(19) United States
(12) Patent Application Publication
(10) Pub. No.: US 2026/0149492 A1
(43) Pub. Date: May 28, 2026

(54) CONFIGURATION FOR GROUP COMMON CSI-RS FOR SUB-BAND DFT GROUP SELECTION

(71) Applicant: Lenovo (United States) Inc., Morrisville, NC (US)

(72) Inventors: Ali Ramadan ALI, Kraiburg am Inn (DE); Karthikeyan GANESAN, Nauheim (DE)

(21) Appl. No.: 18/962,976

(22) Filed: Nov. 27, 2024

(51) Int. Cl. H04B 7/06; H04B 17/318; H04L 27/26; H04W 24/10

(52) U.S. Cl. CPC H04B 7/0626; H04B 17/328; H04L 27/265; H04W 24/10

(57) ABSTRACT

Various aspects of the present disclosure relate to a User Equipment (UE) configured to or operable to receive a configuration that indicates a set of Group Common Channel State Information Reference Signal (GC-CSI-RS) resources comprising subsets of GC-CSI-RS resources, wherein each subset of GC-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks (RBs) in a frequency domain.

### TECHNICAL FIELD

The present disclosure relates to wireless communications, and more specifically to group common channel state information reference signals (GC-CSI-RSs) for discrete Fourier transform (DFT) groups.

### BACKGROUND

A wireless communications system may include one or multiple network communication devices, otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-Advanced (5G-A), sixth generation (6G), etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to receive, from a base station, a configuration that indicates a set of Group Common Channel State Information Reference Signal (GC-CSI-RS) resources comprising subsets of GC-CSI-RS resources, wherein each subset of GC-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain, transmit, to the base station, a report that indicates a corresponding measurement value associated with at least one subset of CG-CSI-RS resources, or a request to join a DFT group based at least in part on the corresponding measurement value for the at least one subset of CG-CSI-RS resources, or both, and receive, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE.

A method performed or performable by a UE for wireless communication is described. The method may include receiving, from a base station, a configuration that indicates a set of GC-CSI-RS resources comprising subsets of GC-CSI-RS resources, wherein each subset of GC-CSI-RS resources is associated with a corresponding DFT group of a set of DFT groups, wherein each DFT group is associated with one or more corresponding subbands of a set of subbands, and wherein each subband consists of contiguous resource blocks in a frequency domain, transmitting, to the base station, a report that indicates a corresponding measurement value associated with at least one subset of CG-CSI-RS resources, or a request to join a DFT group based at least in part on the corresponding measurement value for the at least one subset of CG-CSI-RS resources, or both, and receiving, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE.

In some implementations of the UE and method described herein, the corresponding measurement value comprises a Reference Signal Received Power (RSRP) value, or a Signal-to-Noise-Ratio (SINR), or both, and wherein the report further indicates a CSI-RS resource index (CRI) associated with the at least one subset of GC-CSI-RS resources.

Some implementations of the UE and method described herein, the UE may be configured to, capable of, or operable to perform measurements on each of the subsets of GC-CSI-RS resources, wherein the report is transmitted based at least in part on the performed measurement on each of the subsets of GC-CSI-RS resources.

Some implementations of the UE and method described herein, the UE may be configured to, capable of, or operable to determine that a measurement value associated with a subset of GC-CSI-RS resources corresponding to the current DFT group configured for the UE is less than or equal to a threshold value based at least in part on the performed measurements. In some implementations of the UE and method described herein, the report including the request to join the DFT group is transmitted based at least in part on the measurement value associated with the subset of GC-CSI-RS resources corresponding to the current DFT group configured for the UE being less than or equal to the threshold value.

In some implementations of the UE and method described herein, the DFT group corresponds to a highest measurement value of a plurality of measurement values associated with the subsets of GC-CSI-RS resources. In some implementations of the UE and method described herein, the report including the request to join the DFT group is transmitted based at least in part on the DFT group corresponding to the highest measurement value of the plurality of measurement values associated with the subsets of GC-CSI-RS resources.

In some implementations of the UE and method described herein, the configuration information indicates one or more of a number of resources corresponding to the DFT group, a beginning resource corresponding to the DFT group, or a common Demodulation Reference Signal (DMRS) configuration information.

In some implementations of the UE and method described herein, the configuration information, or the reconfiguration, or both further indicate a set of dedicated resources in a time domain.

In some implementations of the UE and method described herein, the rejection of the request for the UE to join the DFT group further includes a cause for the rejected request.

In some implementations of the UE and method described herein, the reconfiguration indicates one or more updated parameters. In some implementations of the UE and method described herein, the one or more updated parameters comprises an updated number of resources corresponding to the DFT group.

In some implementations of the UE and method described herein, a number of RBs and a number of symbols of each DFT group in the set of DFT groups are the same.

In some implementations of the UE and method described herein, the reconfiguration indicates one or more of an updated Modulation and Coding Scheme (MCS) value, an updated number of resource blocks for the current DFT group, or an updated number of symbols for the current DFT group.

A base station for wireless communication is described. The base station may be configured to, capable of, or operable to transmit, UE, a configuration that indicates a set of CG-CSI-RS resources comprising subsets of CG-CSI-RS resources, wherein each subset of CG-CSI-RS resources is associated with a corresponding DFT group of a set of DFT groups, wherein each DFT group is associated with one or more corresponding subbands of a set of subbands, and wherein each subband consists of contiguous resource blocks in a frequency domain, receive, from the UE, a report that indicates a corresponding measurement value associated with at least one subset of CG-CSI-RS resources, or a request to join a DFT group based at least in part on the corresponding measurement value for the at least one subset of CG-CSI-RS resources, or both, and transmit, to the UE, feedback based at least in part on the received report, wherein the feedback indicates one more of an acceptance of the request for the UE to join the DFT group, configuration information for the DFT group, a rejection of the request for the UE to join the DFT group, or a reconfiguration for a current DFT group configured for the UE by the base station.

In some implementations of the base station described herein, the corresponding measurement value comprises a Reference Signal Received Power (RSRP) value, or a Signal-to-Noise-Ratio (SINR), or both, and wherein the report further indicates a CSI-RS resource index (CRI) associated with the at least one subset of GC-CSI-RS resources.

In some implementations of the base station described herein, the DFT group corresponds to a highest measurement value of a plurality of measurement values associated with the subsets of GC-CSI-RS resources, and wherein the report including the request to join the DFT group is based at least in part on the DFT group corresponding to the highest measurement value of the plurality of measurement values associated with the subsets of GC-CSI-RS resources.

In some implementations of the base station described herein, the reconfiguration indicates one or more updated parameters, and wherein the one or more updated parameters comprises an updated number of resources corresponding to the DFT group.

In some implementations of the base station described herein, the configuration information indicates one or more of a number of resources corresponding to the DFT group, a beginning resource corresponding to the DFT group, or a common DMRS configuration information.

In some implementations of the base station described herein, the configuration information, or the reconfiguration, or both further indicate a set of dedicated resources in a time domain.

In some implementations of the base station described herein, the rejection of the request for the UE to join the DFT group further includes a cause for the rejected request.

### BRIEF DESCRIPTION OF THE DRAWINGS

FIG. 1 illustrates an example of a wireless communications system in accordance with aspects of the present disclosure.

FIG. 2 illustrates an example of DFT groups of UEs in accordance with aspects of the present disclosure.

FIG. 3 illustrates an example of DFT-s-OFDM in a downlink channel in accordance with aspects of the present disclosure.

FIG. 4 illustrates an example of handling a UE request to join a DFT group in accordance with aspects of the present disclosure.

FIG. 5 illustrates another example of handling a UE request to join a DFT group in accordance with aspects of the present disclosure.

FIG. 6 illustrates another example of handling a UE request to join a DFT group in accordance with aspects of the present disclosure.

FIG. 7 illustrates an example of a process for group reselection between DFT groups with flexible sizes in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a NE in accordance with aspects of the present disclosure.

FIG. 11 illustrates a flowchart of method performed by a UE in accordance with aspects of the present disclosure.

FIG. 12 illustrates a flowchart of method performed by a NE in accordance with aspects of the present disclosure.

### DETAILED DESCRIPTION

Cyclic Prefix-Orthogonal Frequency Division Multiplexing (CP-OFDM) based waveforms have been adopted for downlink (DL) as well as for uplink (UL) in 5G New Radio (NR), and Discrete Fourier Transform-Spread OFDM (DFT-s-OFDM) waveforms have been adopted only for UL. DFT-s-OFDM is similar to single carrier frequency division multiple access (SC-FDMA) where each user or transmitter is allocated a single carrier and a finite portion of the channel bandwidth, and every user is separated from the adjacent users with a finite amount of spacing to prevent interference. DFT-s-OFDM eliminates the need for spacing between users and combines all the users orthogonally such that the peak of one user coincides with the null of other users. DFT is a technique that converts a discrete set of input signal sequences in the time domain into discrete components in the frequency domain.

CP-OFDM degrades power efficiency due to a high peak to average power ratio (PAPR) and the need for backoff at transmission which limits the achievable coverage. Network performance can be improved by extending DL coverage and energy savings. Adopting a low peak to average power ratio (PAPR) waveform such as DFT-s-OFDM for DL has the potential to achieve both network energy savings and improved coverage.

For using DFT-s-OFDM in DL, if the number of scheduled UEs in DL increases, the benefit of using DFT-s-OFDM decreases since the gain of PAPR reduction depends on the DFT length of resources allocated to each UE in the carrier bandwidth. The longer the DFT spreading, the lower the PAPR that can be achieved. To achieve a low PAPR for DL, a single DFT spreading may be applied to the resources allocated to a plurality of UEs in a DL channel, e.g. a physical downlink shared channel (PDSCH).

A group of UEs sharing the same sub-band DFT may be served by a common beam for which data and a demodulation reference signal (DMRS) are beamformed with the same spatial filter. When a UE moves to a different location, the UE may need to be configured with a different serving beam, in which case scheduling a UE to move from one sub-band DFT group to another DFT group is performed. There are currently no processes for configuring a UE to move from one DL sub-band DFT group to a different sub-band DFT group. Accordingly, embodiments of the present disclosure provide a UE, a base station (e.g. a network equipment) and methods for configuring a UE for sub-band DFT group selection and UE handover between different sub-band DFT groups.

Aspects of the present disclosure are described in the context of a wireless communications system.

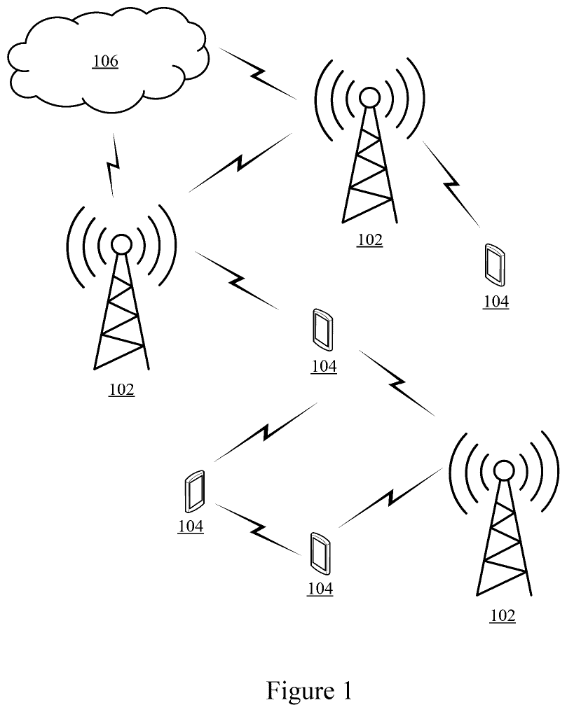

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz—7.125 GHz), FR2 (24.25 GHz—52.6 GHz), FR3 (7.125 GHz—24.25 GHz), FR4 (52.6 GHz—114.25 GHz), FR4a or FR4-1 (52.6 GHz—71 GHz), and FR5 (114.25 GHz—300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

When DFT-s-OFDM in used in DL, increasing the length of DFT spreading lowers an achievable PAPR. To reduce PAPR in DL, a single DFT can be applied to a sub-band created using a contiguous group of resource blocks (RBs) in the frequency domain where a group of UEs are allocated within the sub-band to enhance the coverage. DFT spreading may be applied to sub-bands of data and/or control channels of multiple UEs. The sub-band bandwidth may be related to bandwidth part (BWP) bandwidth, or may be configured within a BWP bandwidth such that a BWP contains a plurality of sub-bands.

To benefit from sub-band DFT, a plurality of UEs sharing the same DFT may be grouped based on the serving beam or detected synchronization signal block (SSB) beams. For example, UEs located in the same direction of a beam can be served by a single beam and single DFT spreading. This grouping is useful to allow sending group common DMRS (beamformed based on serving beam) that cover the frequency band shared between the UEs in the group.

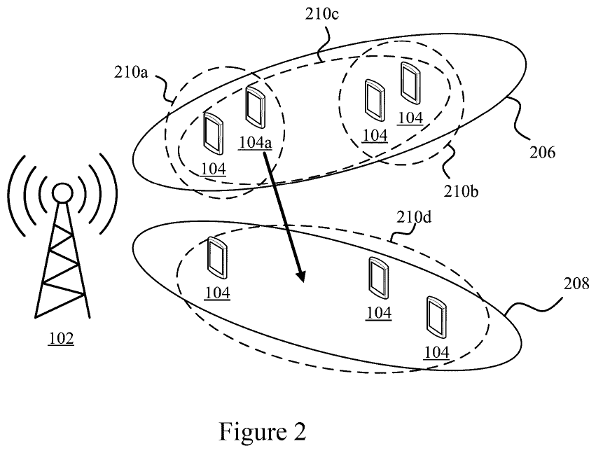

FIG. 2 illustrates an example of DFT groups of UEs in accordance with aspects of the present disclosure. FIG. 2 shows a first beam 206 which is associated with four UEs 104, and a second beam 208 which is associated with three different UEs 104. The beams 206 and 208 may be, for example, synchronization signal block (SSB) beams or serving beams. The UEs 104 associated with beam 206 may be grouped together in a first DFT group 210c, and the UEs associated with beam 208 may be grouped together in a second DFT group 210d.

Each set of UEs 104 associated with an individual beam 208 transmitted by NE 102 may be grouped together for purposes of sharing the same DFT sub-band for DL signaling. In some embodiments, the UEs 104 may be grouped according to proximity to a serving base station, e.g. NE 102 in FIG. 2. UEs 104 with a close proximity to the NE 102 may be grouped together as indicated by a first (near) proximity DFT group 210a, and UEs with further proximity may be grouped together by a second (far) proximity DFT group 210b.

UEs 104 may be grouped by one or both of their proximity to a serving base station (e.g. NE 102) and a beam (e.g. SSB beam or serving beam) associated with the UE.

When a UE (e.g., UE 104a in FIG. 2) moves away from the beam 206 of DFT group 210c, a group reselection for UE 104a may be performed. In an embodiment of the present disclosure, the NE 102 may transmit multiple group common channel state information (CSI) reference signals (RS) (GC-CSI-RS) to the UE 104a for measuring the different group common beams and report the measurement to assist the NE 102 with group reselection. As a result, the UE 104a may move from DFT group 210c associated with first beam 206 to DFT group 210d associated with second beam 208.

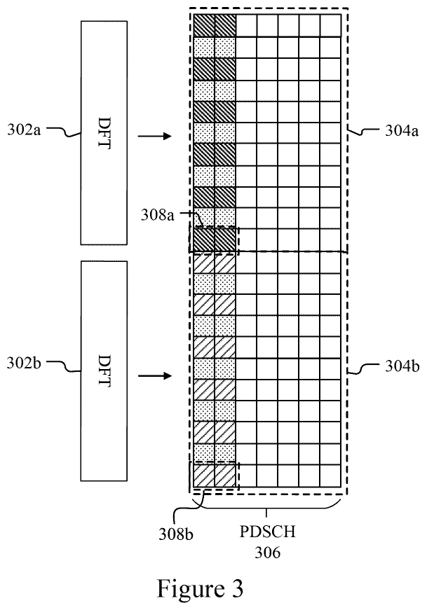

FIG. 3 illustrates an example of DFT-s-OFDM in a downlink channel in accordance with aspects of the present disclosure. In some embodiments, sub-band DFTs 302 for different DFT groups 210 may have fixed DFT sizes in terms of the number of resource elements (REs) and symbols associated with the DFT. Accordingly, a number of RBs and a number of symbols of each DFT group 210 in the set of DFT groups may be the same.

For example, a BWP may be divided into multiple sub-bands 304 for DFT spreading, and each of the sub-bands 304 may have a fixed number or RBs. In FIG. 3, a first DFT 302a is used to spread a first sub-band 304a of a physical downlink shared channel (PDSCH) 306, and a second DFT 302a is used to spread a second sub-band 304b. Each of the sub-bands 304 and DFTs 302 are associated with a different DFT group 210. A first group-common DMRS 308a is used for the first sub-band 304a, and a second group-common DMRS 308b is used for the second sub-band 304b.

The number of RBs or symbols in a sub-band 304 corresponds to the DFT length, which may also be referred to as DFT size. Each UE 104 may be configured with a set of dedicated CSI-RS resources and a set of GC-CSI-RS resources. Thes GC-CSI-RSs may be beamformed and transmitted with multiple beams in different directions within potential locations of the UE 104a. For example, the GC-CSI-RSs may be transmitted in one or more beams which are adjacent to the serving beam for the UE 104a.

In an embodiment, each GC-CSI-RS may be transmitted with a narrow beam within an SSB beam detected by the UE 104a or quasi co-located (QCLed) with an SSB beam detected by the UE. These reference signal resources are used by the UE 104a to measure the channel on the different beams and report measurement data, e.g. measurement values and/or related information, to the NE 102 to reallocate the UE 104a in a suitable sub-band DFT group 210, e.g., the DFT group 210 associated with the highest reference signal received power (RSRP) of reference signals measured by the UE 104a.

A GC-CSI-RS configuration associated with multiple sub-band DFT groups may be transmitted via radio resource control (RRC) signaling by a configuration message, e.g. as part of CSI-RS-ResourceConfig. The configuration may include resource location, pattern, density, and periodicity for each GC-CSI-RS. The UE 104a may be configured to report feedback for the measured GC-CSI-RSs to the NE 102 for group reselection.

In one implementation, a NE 102 configures the UE 104a to send a request for joining a new group based on measurements of the GC-CSI-RSs of different DFT groups 210. The UE 104a may be configured (e.g. either pre-configured, or configured by the NE 102) with a measurement threshold for GC-CSI-RS channels. The UE 104a may transmit a request to join a new DFT group 210 if one or more measurement associated with that group, e.g., an RSRP of a GC-CSI-RS QCLed with the current serving beam, is equal to or below the threshold, and configured to transmit an indication of an GC-CSI-RS whose RSRP is the highest among the measured GC-CSI-RS resources configured for measurement.

Put another way, the UE 104a may be configured to perform a reselection process by transmitting a request to join a new DFT group 210 to its serving NE 102 when a signal strength value of a GC-CSI-RS associated with the serving beam is below a threshold value. The UE 104a may be further configured to measure GC-CSI-RSs of one or more adjacent beam groups, and transmit an indication to join the DFT group 210 associated with the highest measured GC-CSI-RS value.

In another implementation, the NE 102 configures the UE 104a to report measurement data including measurement values of multiple GC-CSI-RS resources to the NE. The report may comprise CSI-RS resource indicator (CRI) data such as CRI-RSRP, CRI-SINR, etc. for each DFT group 210 of a set of DFT groups (e.g. a set associated with the CRI). The NE 102 may configure the UE 104a to report CRIs of a predetermined number of CSI-RS groups, e.g., for the n GC-CSI-RSs with the highest measurement values, where n is an integer greater than one.

This report may be used by a NE 102 to select an appropriate sub-band DFT group for the reporting UE 104a. The selection may depend on available resources of the potential sub-band DFT group(s). For example, if the UE 104a is configured to send a request to join a specific group and there are available resources for the PDSCH of the requested DFT group 210, the NE 102 may schedule the UE 104a to the corresponding group configure the UE 104a with parameters of the new sub-band DFT group. The parameters may include, for example, a DFT size, a starting RB, a starting symbol, a common DMRS configuration, etc. Put another way, configuration information transmitted by the NE 102 indicates one or more of a number of resources corresponding to the DFT group, a beginning resource corresponding to the DFT group, or a common Demodulation Reference Signal (DMRS) configuration information.

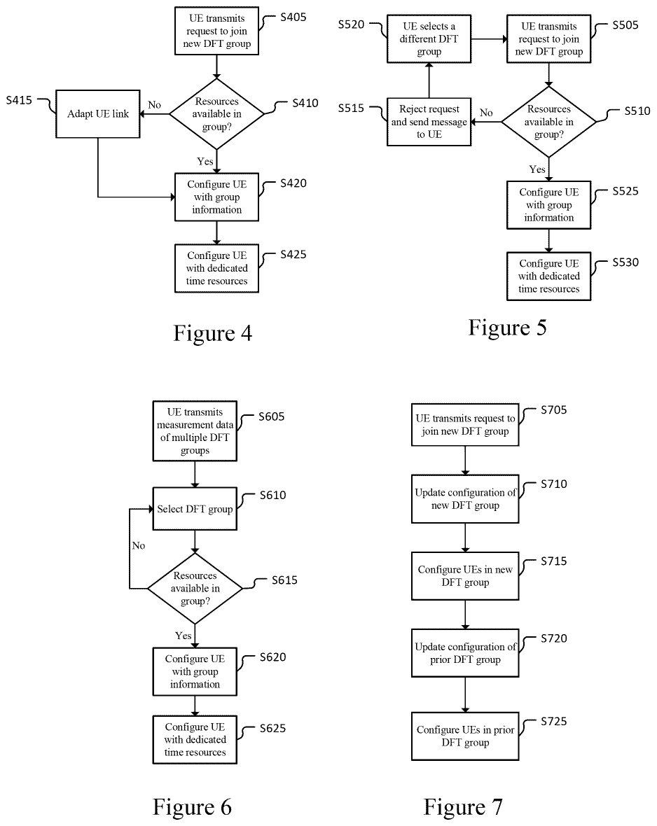

Multiple embodiments are possible for handling UE reselection based on whether resources are available for one or more DFT group 210 requested by a UE 104a. FIG. 4 illustrates an example of one embodiment of handling a UE request in accordance with aspects of the present disclosure. In the Example of FIG. 4, a UE 104a transmits a request to join a new DFT group 210 to a NE 102 at S405. At S410, the NE 102 checks whether resources are available in the DFT group 210 requested by the UE 104a.

When no or inadequate resources are available in the DFT group 210, the NE 102 adapts the UE link of the requested DFT group, e.g. the modulation and coding scheme (MCS), number of RBs, or other parameters of the UE link to accommodate the UE 104a at S415. When multiple DFT groups 210 are requested by the UE 104a and none of the groups are available, the NE 102 may adapt the parameters of the best DFT group 210, e.g. the DFT group associated with the highest reported GC-CSI-RS value.

At S420, the NE 102 configures the UE 104a with group information for the selected DFT group 210, e.g. the DFT group of the adapted link or the available DFT group requested by the UE. The group information may include, for example, parameters such as a DFT size, a starting RB, a starting symbol, a common DMRS configuration, etc. of the DFT group 210. At S425, the NE 102 configures the UE 104a with dedicated time resources of the selected DFT group 210.

In some embodiments, the process of FIG. 4 may be performed when the UE 104a transmits a request to join more than one DFT group 210 at S405. For example, if resources are not available in any of the DFT groups 210 requested by the UE, the NE 102 may adapt the configuration of one of the DFT groups requested by the UE at S415 so that the UE can join the group with the adapted configuration.

FIG. 5 illustrates an example of another embodiment of handling a UE request to join a DFT group in accordance with aspects of the present disclosure. In the example of FIG. 5, a UE 104a transmits a request to join a new DFT group 210 to a NE 102 at S505. At S510, the NE 102 checks whether resources are available in the DFT group 210 requested by the UE 104a.

When no or inadequate resources are available in the DFT group 210, the NE 102 rejects the request and sends feedback to the UE 104a. In an example, the NE 102 sends a feedback message, e.g. a NACK message, to the UE 104a. The feedback message may comprise feedback information, e.g. a cause for the rejected request, a list of DFT groups 210 with adequate resources, or other information. In response to the feedback message, the UE 104a selects a different DFT group 210, e.g. a DFT group with a next-highest RSRP value, and transmits a request to join the different DFT group to the NE 102 at S505.

When resources are available for the DFT group 210 requested by the UE 104a, the NE 102 configures the UE with group information for the selected DFT group at S525. The group information may include, for example, parameters such as a DFT size, a starting RB, a starting symbol, a common DMRS configuration, etc. of the DFT group 210. At S530, the NE 102 configures the UE 104a with dedicated time resources of the selected DFT group 210.

FIG. 6 illustrates an example of another embodiment of handling a UE request to join a DFT group in accordance with aspects of the present disclosure. In the embodiment of FIG. 6, a UE 104a transmits measurement data of plurality of GC-CSI-RSs associated with plurality of sub-band DFT groups 210 to a NE 102 at S605. The NE 102 selects a DFT group 210 associated with a GC-CSI-RS from the plurality of GC-CSI-RSs at S610 and checks whether resources are available in the selected DFT group at S615. The NE 102 may select a DFT group 210 associated with the highest reported RSRP value first, and if no resources are available in that DFT group, the NE selects another DFT group (e.g. the DFT group with the second-highest RSRP value) at S610. This process is repeated until the NE 102 identifies a DFT group 210 with available resources. In some embodiments, if no suitable DFT groups 210 have available resources, the NE 102 adapts the resources of a DFT group as described with respect to FIG. 4 so that resources in that group are available.

When resources are available for the DFT group 210 requested by the UE 104a, the NE 102 configures the UE with group information for the selected DFT group at S620. The group information may include, for example, parameters such as a DFT size, a starting RB, a starting symbol, a common DMRS configuration, etc. of the DFT group 210. At S625, the NE 102 configures the UE 104a with dedicated time resources of the selected DFT group 210.

In some embodiments, the sub-bands 304 of DFT groups 210 have a flexible DFT size that can be adapted by a NE 102. The BWP of a DL channel (e.g. a PDSCH 306) may be divided into multiple sub-bands 304, each sub-band being associated with a DFT 302. The specific number of REs and symbols in each sub-band may be adapted, and the DFT size of the DFT 302 associated with the sub-band 304 changes along with the number of REs/symbols.

A NE 102 may transmit a configuration to a UE 104a for one or more group common CSI-RS (GC-CSI-RS) resources. These GC-CSI-RSs may be beamformed and transmitted with multiple beams in different directions within the potential location of the UE 104a. For example, a GC-CSI-RS may be transmitted with a narrow beam within an SSB beam detected by the UE 104a or QCLed with SSB beam detected by the UE. These GC-CRI-RS resources are used by the UE 104a to measure the channel on the different beams and report the measurements and/or related information to the NE 102 to reallocate the UE in a suitable sub-band DFT group 210, e.g., the group whose beam is measured by the UE with highest RSRP.

A GC-CSI-RS configuration associated with multiple sub-band DFT groups 210 may be transmitted via RRC as part of CSI-RS-ResourceConfig which includes resource location, pattern, density, and periodicity for each reference signal group. The UE 104a is configured to report feedback on one or more measured GC-CSI-RS to the NE 102 for group reselection.

In one implementation, a NE 102 configures a UE 104a to report, using a physical uplink shared channel (PUSCH) or using uplink control information (UCI) over a physical uplink control channel (PUCCH), a request for joining a new DFT group 210 based on GC-CSI-RS measurements for different groups. The UE 104a may be configured by the NE 102 or preconfigured with a measurement threshold for the GC-CSI-RS channel.

The UE 104a requests joining a new group if a measurement value, e.g., a measured RSRP value of the GC-CSI-RS QCLed with a current serving beam, is below a measurement threshold, and is configured to send an indication of the GC-CSI-RS whose RSRP is the highest among the measured GC-CSI-RS resources which the UE 104a is configured to measure. That is, when a signal strength value of the GC-CSI-RS associated with a DFT group 210 to which a UE 104a belongs falls below a threshold value, the UE may measure a set of GC-CSI-RS resources according to a configuration of the UE and transmit a request a request to join the DFT group associated with the highest measured value.

In another implementation, a NE 102 configures the UE 104a to report measurement data of multiple GC-CSI-RS resources. The report may contain CRI-RSRP, CRI-SINR, etc. for each GC-CSI-RS measured by the UE 104a. The NE 102 may configure the UE 104a to report CRIs of a specific number of CSI-RS groups, e.g., for n GC-CSI-RSs with the highest measurement values, where n is an integer greater than one.

FIG. 7 illustrates an example of a process for group reselection between DFT groups with flexible sizes in accordance with aspects of the present disclosure. A UE 104a transmits a request message to join a new DFT group 210 at S705 to a NE 102. As discussed above, the request may comprise measurement data of one or more GC-CSI-RS measured by the UE 104a (e.g. CRIs of measured group common reference signals), and/or an identifier for one or more DFT group 210.

The NE 102 receives the request message from the UE 104a and updates the configuration of a new DFT group 210 at S710. Here, the new DFT group 210 is the group which the UE 104a will join. For example, with respect to FIG. 2, UE 104a is in DFT group 210c and moves to DFT group 210d, which is the new DFT group. In this process, the DFT group 210 which the UE 104a leaves (DFT group 210c) may be referred to as the prior DFT group. Updating the configuration of the new DFT group 210 may include adjusting parameters of the new DFT group to allocate resources of a PDSCH to the UE 104a. The parameters that may be adjusted include one or more of a DFT size, time and frequency resources, a common DMRS, etc.

The NE 102 configures UEs including the UE 104a and other UEs which are currently in the new DFT group 210 by transmitting an updated configuration to the UEs at S715. Similarly, the NE 102 may update the configuration of the prior DFT group 210 at S720 and configure the UEs 104 in the prior DFT group with adjusted parameters at S725.

Various embodiments are possible for configuring UEs in the new and old DFT groups 210 at S715 and S725.

In one implementation, the group configurations are sent to the UEs 104 in both DFT groups 210 using a group common control channel, e.g. a physical downlink control channel (PDCCH) as part of group common search space (GCSS) in the PDCCH. The GCSS, as well as one or more additional search space within a control resource set (CORESET) such as a user specific search space (USS) and common search space (CSS) may be spread with a DFT and transmitted using a DFT-s-OFDM waveform.

Time domain allocation information for the UE 104a in a PDSCH 306 may be sent to the UE 104a in a USS. The NE 102 may update time domain allocation information allocated to UEs 104 in the PDSCH 306 transmit configurations indicating the updated time domain resources to each UE.

In another implementation, the group configurations are sent to UEs 104 in the prior and new DFT groups 210 using a common search space (CSS) of a Type3-PDCCH, or as part of a dedicated group common signaling in a GCSS of a new PDCCH type, e.g. a Type4-PDCCH.

In some implementations, a Type3-PDCCH is used to signal group common information for a plurality of UEs in the same DFT group 210. A Type3-PDCCH CSS set may be configured by the SearchSpace IE in the PDCCH-Config message with searchSpaceType=common for DCI formats with cyclic redundancy prefixes (CRCs) scrambled by a radio network temporary identifier such as a DFT-RNTI, INT-RNTI, SFI-RNTI, TPC-PUSCH-RNTI, TPC-PUCCH-RNTI, TPC-SRS-RNTI, or CI-RNTI.

In other implementations, a new PDCCH type is defined, e.g., a Type4-PDCCH, in which group common information for a DFT group 210 is transmitted to a plurality of UEs 104 in the same DFT group 210. A Type4-PDCCH CSS set may be configured by the SearchSpace IE in PDCCH-Config with searchSpaceType=common for downlink control information (DCI) formats with a CRC scrambled by a sub-band DFT specific RNTI, e.g., a DFT-RNTI.

If a UE 104 monitors PDCCH candidates for DCI formats with CRCs scrambled by a DFT-RNTI and the UE is provided with a non-zero value for searchSpaceID in PDCCH-ConfigCommon for a Type3/4-PDCCH CSS set, the UE may determine monitoring occasions for PDCCH candidates of the Type3/4-PDCCH CSS set based on the search space set associated with the value of searchSpaceID.

Time domain allocation information for a PDSCH of a joining UE may be sent in a UE dedicated search space (USS). The NE 102 may update time domain allocation information for a PDSCH of UEs 104 in the new group and send the configuration to each UE.

Accordingly, upon receiving a UE request for joining a DFT group 210 or receiving UE reports of CRIs of measured GC-CSI-RS groups, NE 102 adjusts the parameters of the new sub-band DFT group 210 to allocate resources of the PDSCH to the joining UE 104a and adjusts the parameters of the prior sub-band DFT group. The NE 102 may send the updated configuration including a new DFT size to the joining UE 104a and UEs 104 in the new DFT group 210, and send the updated configuration including a new DFT size of the prior group's sub-band DFT 210 to the UEs 104 in the prior DFT group.

In the embodiments discussed above, a UE 104a transmits a report to a NE 102 that indicates a corresponding measurement value associated with at least one subset of CG-CSI-RS resources, or a request to join a DFT group 210 based at least in part on a corresponding measurement value for the at least one subset of CG-CSI-RS resources, or both. The NE 102 transmits feedback to a UE 104a based at least in part on a report transmitted by the UE, wherein the feedback indicates one more of an acceptance of the request for the UE to join the DFT group, configuration information for the DFT group, a rejection of the request for the UE to join the DFT group, or a reconfiguration for a current DFT group configured for the UE.

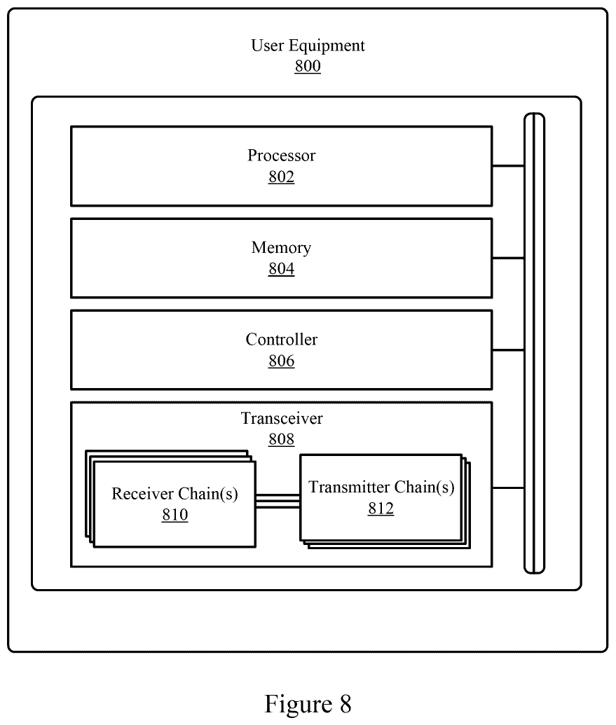

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for receiving, from a base station, a configuration that indicates a set of Group Common Channel State Information Reference Signal (GC-CSI-RS) resources comprising subsets of GC-CSI-RS resources, wherein each subset of GC-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain; transmitting, to the base station, a report that indicates a corresponding measurement value associated with at least one subset of CG-CSI-RS resources, or a request to join a DFT group based at least in part on the corresponding measurement value for the at least one subset of CG-CSI-RS resources, or both; and receiving, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

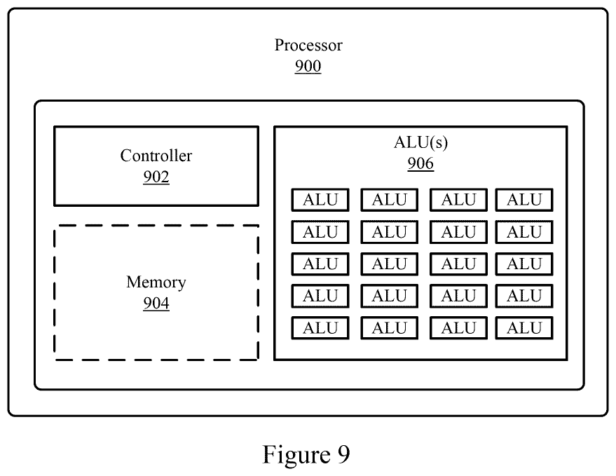

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to or operable to support a means for receiving, from a base station, a configuration that indicates a set of Group Common Channel State Information Reference Signal (GC-CSI-RS) resources comprising subsets of GC-CSI-RS resources, wherein each subset of GC-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain; transmitting, to the base station, a report that indicates a corresponding measurement value associated with at least one subset of CG-CSI-RS resources, or a request to join a DFT group based at least in part on the corresponding measurement value for the at least one subset of CG-CSI-RS resources, or both; and receiving, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE.

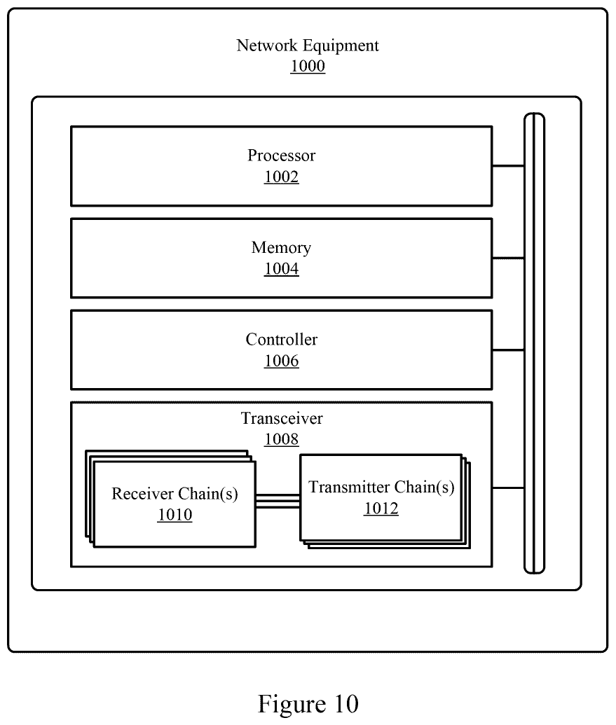

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for transmitting, to a UE, a configuration that indicates a set of Group Common Channel State Information Reference Signal (CG-CSI-RS) resources comprising subsets of CG-CSI-RS resources, wherein each subset of CG-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain; receiving, from the UE, a report that indicates a corresponding measurement value associated with at least one subset of CG-CSI-RS resources, or a request to join a DFT group based at least in part on the corresponding measurement value for the at least one subset of CG-CSI-RS resources, or both; and transmitting, to the UE, feedback based at least in part on the received report, wherein the feedback indicates one more of an acceptance of the request for the UE to join the DFT group, configuration information for the DFT group, a rejection of the request for the UE to join the DFT group, or a reconfiguration for a current DFT group configured for the UE by the base station.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or a wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

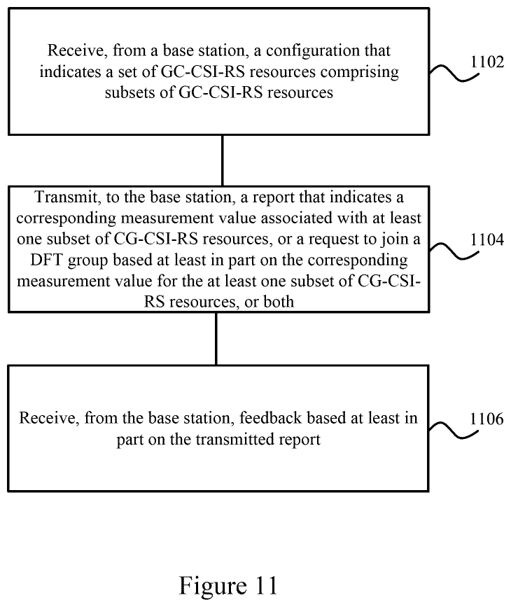

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving, from a base station, a configuration that indicates a set of GC-CSI-RS resources comprising subsets of GC-CSI-RS resources, wherein each subset of GC-CSI-RS resources is associated with a corresponding DFT group of a set of DFT groups, wherein each DFT group is associated with one or more corresponding subbands of a set of subbands, and wherein each subband consists of contiguous resource blocks in a frequency domain;. The operations of 1102 may be performed in accordance with examples as described herein. In some implementations, aspects of the operations of 1102 may be performed by a UE as described with reference to FIG. 8.

At 1104, the method may include transmitting, to the base station, a report that indicates a corresponding measurement value associated with at least one subset of CG-CSI-RS resources, or a request to join a DFT group based at least in part on the corresponding measurement value for the at least one subset of CG-CSI-RS resources, or both. The operations of 1104 may be performed in accordance with examples as described herein. In some implementations, aspects of the operations of 1104 may be performed by a UE as described with reference to FIG. 8.

At 1106, the method may include receiving, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE. The operations of 1106 may be performed in accordance with examples as described herein. In some implementations, aspects of the operations of 1106 may be performed a UE as described with reference to FIG. 8.

It should be noted that the method described herein describes a possible implementation, and that the operations and the steps may be rearranged or otherwise modified and that other implementations are possible.

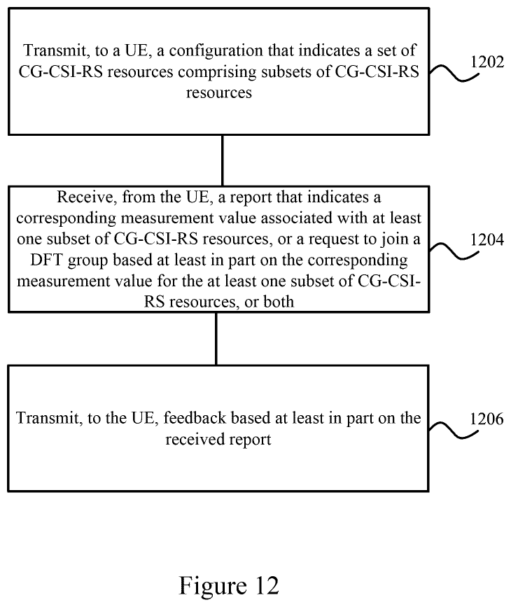

FIG. 12 illustrates a flowchart of a method in accordance with aspects of the present disclosure. The operations of the method may be implemented by a NE as described herein. In some implementations, the NE may execute a set of instructions to control the function elements of the NE to perform the described functions.

At 1202, the method may include transmitting, to a UE, a configuration that indicates a set of CG-CSI-RS resources comprising subsets of CG-CSI-RS resources, wherein each subset of CG-CSI-RS resources is associated with a corresponding DFT group of a set of DFT groups, wherein each DFT group is associated with one or more corresponding subbands of a set of subbands, and wherein each subband consists of contiguous resource blocks in a frequency domain. The operations of 1202 may be performed in accordance with examples as described herein. In some implementations, aspects of the operations of 1202 may be performed by a NE as described with reference to FIG. 10.

At 1204, the method may include receiving, from the UE, a report that indicates a corresponding measurement value associated with at least one subset of CG-CSI-RS resources, or a request to join a DFT group based at least in part on the corresponding measurement value for the at least one subset of CG-CSI-RS resources, or both. The operations of 1204 may be performed in accordance with examples as described herein. In some implementations, aspects of the operations of 1204 may be performed by a NE as described with reference to FIG. 10.

At 1206, the method may include transmitting, to the UE, feedback based at least in part on the received report, wherein the feedback indicates one more of an acceptance of the request for the UE to join the DFT group, configuration information for the DFT group, a rejection of the request for the UE to join the DFT group, or a reconfiguration for a current DFT group configured for the UE by the base station. The operations of 1206 may be performed in accordance with examples as described herein. In some implementations, aspects of the operations of 1206 may be performed a NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a base station, a configuration that indicates a set of Group Common Channel State Information Reference Signal (GC-CSI-RS) resources comprising subsets of GC-CSI-RS resources, wherein each subset of GC-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain;
transmit, to the base station, a report that indicates a corresponding measurement value associated with at least one subset of CG-CSI-RS resources, or a request to join a DFT group based at least in part on the corresponding measurement value for the at least one subset of CG-CSI-RS resources, or both; and
receive, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE.

2. The UE of claim 1, wherein the corresponding measurement value comprises a Reference Signal Received Power (RSRP) value, or a Signal-to-Noise-Ratio (SINR), or both, and wherein the report further indicates a CSI-RS resource index (CRI) associated with the at least one subset of GC-CSI-RS resources.

3. The UE of claim 1, wherein the at least one processor is further configured to cause the UE to:
perform measurements on each of the subsets of GC-CSI-RS resources,
wherein the report is transmitted based at least in part on the performed measurement on each of the subsets of GC-CSI-RS resources.

4. The UE of claim 3, wherein the at least one processor is further configured to cause the UE to:
determine that a measurement value associated with a subset of GC-CSI-RS resources corresponding to the current DFT group configured for the UE is less than or equal to a threshold value based at least in part on the performed measurements,
wherein the report including the request to join the DFT group is transmitted based at least in part on the measurement value associated with the subset of GC-CSI-RS resources corresponding to the current DFT group configured for the UE being less than or equal to the threshold value.

5. The UE of claim 1, wherein the DFT group corresponds to a highest measurement value of a plurality of measurement values associated with the subsets of GC-CSI-RS resources, and wherein the report including the request to join the DFT group is transmitted based at least in part on the DFT group corresponding to the highest measurement value of the plurality of measurement values associated with the subsets of GC-CSI-RS resources.

6. The UE of claim 1, wherein the configuration information indicates one or more of a number of resources corresponding to the DFT group, a beginning resource corresponding to the DFT group, or a common Demodulation Reference Signal (DMRS) configuration information.

7. The UE of claim 1, wherein the configuration information, or the reconfiguration, or both further indicate a set of dedicated resources in a time domain.

8. The UE of claim 1, wherein the rejection of the request for the UE to join the DFT group further includes a cause for the rejected request.

9. The UE of claim 1, wherein the reconfiguration indicates one or more updated parameters, and wherein the one or more updated parameters comprises an updated number of resources corresponding to the DFT group.

10. The UE of claim 1, wherein a number of RBs and a number of symbols of each DFT group in the set of DFT groups are the same.

11. The UE of claim 1, wherein the reconfiguration indicates one or more of an updated Modulation and Coding Scheme (MCS) value, an updated number of resource blocks for the current DFT group, or an updated number of symbols for the current DFT group.

12. A processor for wireless communication, comprising:
at least one controller coupled with at least one memory and configured to cause the processor to:
receive, from a base station, a configuration that indicates a set of Group Common Channel State Information Reference Signal (GC-CSI-RS) resources comprising subsets of GC-CSI-RS resources, wherein each subset of GC-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain;
transmit, to the base station, a report that indicates a corresponding measurement value associated with at least one subset of CG-CSI-RS resources, or a request to join a DFT group based at least in part on the corresponding measurement value for the at least one subset of CG-CSI-RS resources, or both; and
receive, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE.

13. A method performed by a user equipment (UE), the method comprising:
receiving, from a base station, a configuration that indicates a set of Group Common Channel State Information Reference Signal (GC-CSI-RS) resources comprising subsets of GC-CSI-RS resources, wherein each subset of GC-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain;
transmitting, to the base station, a report that indicates a corresponding measurement value associated with at least one subset of CG-CSI-RS resources, or a request to join a DFT group based at least in part on the corresponding measurement value for the at least one subset of CG-CSI-RS resources, or both; and
receiving, from the base station, feedback based at least in part on the transmitted report, wherein the feedback indicates one more of an acceptance of the request for the UE to join the DFT group, configuration information for the DFT group, a rejection of the request for the UE to join the DFT group, or a reconfiguration for a current DFT group configured for the UE.

14. A base station for wireless communication, comprising:
at least one memory; and
at least one processor coupled with the at least one memory and configured to cause the base station to:
transmit, to a user equipment (UE), a configuration that indicates a set of Group Common Channel State Information Reference Signal (CG-CSI-RS) resources comprising subsets of CG-CSI-RS resources, wherein each subset of CG-CSI-RS resources is associated with a corresponding Discrete Fourier Transform (DFT) group of a set of DFT groups, wherein each DFT group is associated with one or more corresponding subbands of a set of subbands, and wherein each subband consists of contiguous resource blocks in a frequency domain;
receive, from the UE, a report that indicates a corresponding measurement value associated with at least one subset of CG-CSI-RS resources, or a request to join a DFT group based at least in part on the corresponding measurement value for the at least one subset of CG-CSI-RS resources, or both; and
transmit, to the UE, feedback based at least in part on the received report, wherein the feedback indicates one more of an acceptance of the request for the UE to join the DFT group, configuration information for the DFT group, a rejection of the request for the UE to join the DFT group, or a reconfiguration for a current DFT group configured for the UE by the base station.

15. The base station of claim 14, wherein the corresponding measurement value comprises a Reference Signal Received Power (RSRP) value, or a Signal-to-Noise-Ratio (SINR), or both, and wherein the report further indicates a CSI-RS resource index (CRI) associated with the at least one subset of GC-CSI-RS resources.

16. The base station of claim 14, wherein the DFT group corresponds to a highest measurement value of a plurality of measurement values associated with the subsets of GC-CSI-RS resources, and wherein the report including the request to join the DFT group is based at least in part on the DFT group corresponding to the highest measurement value of the plurality of measurement values associated with the subsets of GC-CSI-RS resources.

17. The base station of claim 14, wherein the reconfiguration indicates one or more updated parameters, and wherein the one or more updated parameters comprises an updated number of resources corresponding to the DFT group.

18. The base station of claim 14, wherein the configuration information indicates one or more of a number of resources corresponding to the DFT group, a beginning resource corresponding to the DFT group, or a common Demodulation Reference Signal (DMRS) configuration information.

19. The base station of claim 14, wherein the configuration information, or the reconfiguration, or both further indicate a set of dedicated resources in a time domain.

20. The base station of claim 14, wherein the rejection of the request for the UE to join the DFT group further includes a cause for the rejected request.
